(19) United States
(12) Patent Application Publication
(10) Pub. No.: US 2008/0188574 A1
(43) Pub. Date: Aug. 7, 2008

(54) DISPERSE SYSTEM HAVING FINE POWDER-TYPED INORGANIC METAL OXIDE DISPERSED IN WATER AND PREPARING METHOD FOR THE SAME

(75) Inventors: Sung-Ho Lee, Seoul (KR); Woo-Kyu Kang, Gunpo City (KR)

Correspondence Address: LEXYOUME IP GROUP, LLC, 1233 TWENTIETH STREET, N.W., SUITE 701, WASHINGTON, DC, 20036, US

(73) Assignees: SUNJIN CHEMICAL Co., Ltd., Ansan City (KR); RANCO CO., Ltd., Chungju-City (KR)

(21) Appl. No.: 11/751,120

(22) Filed: May 21, 2007

(30) Foreign Application Priority Data
Feb. 2, 2007 (KR) 10-2007-0010965

(51) Int. Cl. B01F 17/54; B01F 3/12

(52) U.S. Cl. 516/79; 516/88; 516/90; 516/93

(57) ABSTRACT

This invention provides a disperse system having fine powder-typed inorganic metal oxide dispersed in water and preparing method for the same and more particularly, it provides a method for preparing a disperse system having fine powder-typed inorganic metal oxide dispersed in water characterized in that a) a hydrophobically treated fine powder-typed inorganic metal oxide; b) a sulfosuccinate or sulfosuccinamate or an alkoxylated alcohol dispersant; and c) water are mixed and dispersed by a high-speed bead mill and a disperse system having fine powder-typed inorganic metal oxide dispersed in water prepared by the same.

The disperse system having fine powder-typed inorganic metal oxide dispersed in water of the present invention has excellent characteristics in that it has high transparency in the visible ray spectrum, it has excellent UV protection ability when applied to cosmetics, it provides better feelings than oil dispersions, and it has better water-proof property than existing water dispersions.

### BACKGROUND OF THE INVENTION

1. Field of the Invention

This invention relates to a disperse system having fine powder-typed inorganic metal oxide dispersed in water and preparing method for the same and more particularly, to a disperse system having fine powder-typed inorganic metal oxide dispersed in water having excellent characteristics in that it has high transparency in the visible ray spectrum, it has excellent UV protection ability when applied to cosmetics, it provides better feeling than oil dispersions and it has better water-proof property than existing water dispersions, and preparing method for the same.

2. Description of Related Art

As UV protection agents used in cosmetic sunscreen products, there are inorganic oxides such as titanium dioxide (TiO₂), zinc oxide (ZnO) and cerium oxide, and organic benzo phenone, etc.

Of the inorganic oxides among them, titanium dioxide (UVA) and zinc oxide (UVB) are commonly used and in order to raise transparency in the visible light spectral range, fine powders of 50 mm or less which is smaller than the wavelength of the visible ray are used.

However, when added to the compositions of sun products, such fine powder-typed inorganic metal oxides for UV protection were lacking in transparency due to the flocculation of the particles if used in a powder state and showed very low sun protection factors, so they failed to exert sufficient functions.

To compensate the aforementioned drawbacks, preparations were made by dispersing fine powder-typed inorganic metal oxide powders for UV protection in several solvents, i.e., oil or water and combining the obtained dispersions with the ingredients of sun products, which enabled transparency in the visible ray spectrum as well as high sun protection factors because they are dispersed in the state of single particles without flocculated particles.

Of the fine powder-typed inorganic metal oxide (hydrophobic powders) dispersions for UV protection, the oil based dispersions, that is, when the dispersions are prepared by premixing the fine powder-typed inorganic metal oxides with a dispersant in oil and then by using a wet bead mill and they are used as an ingredient of sun products, have heavy feelings due to plenty of oil ingredient and make cleansing difficult.

In addition, of the fine powder-typed inorganic metal oxide (hydrophilic powders) dispersions for UV protection, the water based dispersions, that is, when the dispersions are prepared by premixing the fine powder-typed inorganic metal oxides in water and then by using a wet bead mill and they are used as an ingredient of sun products, have the merit in that they have light feelings due to plenty of water ingredient, but they are easily wiped away with moistures such as sweat, so it is difficult to maintain UV protection ability for a long time.

### SUMMARY OF THE INVENTION

Therefore, it is an object of the present invention to provide a disperse system having fine powder-typed inorganic metal oxide dispersed in water suitable to be applied to sun products as it has light feelings, maintains UV protection ability for a long time due to excellent properties against moisture such as sweat (water proof property) and makes cleansing easy, and preparing method for the same.

Further, it is another object of the invention to provide a cosmetic composition comprising the disperse system having fine powder-typed inorganic metal oxide dispersed in water, which has light feelings, maintains UV protection ability for a long time due to excellent properties against moisture such as sweat (water proof property) and makes cleansing easy.

To achieve the aforementioned objects, the present invention provides a method for preparing a disperse system having fine powder-typed inorganic metal oxide dispersed in water, wherein

a) a hydrophobically treated fine powder-typed inorganic metal oxide;

b) a sulfosuccinate or sulfosuccinamate dispersant; and

c) water are mixed and dispersed by a high-speed bead mill.

Further, the invention provides a method for preparing a disperse system having fine powder-typed inorganic metal oxide dispersed in water, wherein

a) a hydrophobically treated fine powder-typed inorganic metal oxide;

b) an alkoxylated alcohol dispersant; and

c) water are mixed and dispersed by a high-speed bead mill.

Still further, the invention provides a disperse system having fine powder-typed inorganic metal oxide dispersed in water prepared by the above methods.

Further, the invention provides a cosmetic composition comprising the above disperse system having fine powder-typed inorganic metal oxide dispersed in water.

### BRIEF DESCRIPTION OF THE DRAWINGS

FIG. 1 shows the particle diameters of inorganic metal oxides (TiO₂) in the water dispersions prepared by Example 1 according to the present invention.

FIG. 2 shows the particle diameters of inorganic metal oxides (zinc oxide) in the water dispersions prepared by Example 2 according to the present invention.

FIG. 3 shows the particle diameters of inorganic metal oxides (TiO₂) in the water dispersions prepared by Example 3 according to the present invention.

FIG. 4 shows the sun protection factors of the sun creams prepared by Example 6 according to the present invention.

FIG. 5 shows the sun protection factors of the sun creams prepared by Example 7 according to the present invention.

### DETAILED DESCRIPTION OF THE INVENTION

This invention will be further described in detail.

The inventors found that in the preparation of disperse system having fine powder-typed inorganic metal oxide dispersed in water, when hydrophobically treated fine powder-typed inorganic metal oxides and sulfosuccinate or sulfosuccinamate or alkoxylated alcohol dispersions in a certain ratio were mixed with water and dispersed by a high speed bead mill, water based dispersions could be prepared which have high transparency in the visible ray spectrum and light feelings and are excellent in UV protection ability as well as water-proof property against moistures such as sweat and have thus completed the invention.

The method for preparation of a disperse system of having fine powder-typed inorganic metal oxide dispersed in water according to the present invention is characterized in that a) a hydrophobically treated fine powder-typed inorganic metal oxide; b) a sulfosuccinate or sulfosuccinamate or alkoxylated alcohol dispersant; and c) water are mixed and dispersed by a high-speed bead mill.

For the fine powder-typed inorganic metal oxides, titanium dioxide, zinc oxide or cerium oxide can be used either alone or in combination.

In the case of the titanium dioxide, preferably, its particle size is smaller than the visible ray spectral range (350-750 nm), which is approximately ¼ or less the shortest wavelength of the visible ray at which Rayleigh scattering does not occur and more preferably, it is 0.01-0.05 μm, and it can be in any shape, either sphere or needle-like structure.

For example, the hydrophobically treated titanium oxide has a rutile type crystal structure which has low optical activity, its surface can be coated with at least one of aluminum (Al), silicon (Si) or zirconium (Zr) in the form of its hydroxide or oxide, and there can be used one coated with fatty acids stearate or alkyl silane so as to express hydrophobicity at its outermost portion. Either dry or wet coating method can be used. Of course, it is possible to use commercially available products.

The hydroxides and oxides of aluminum (Al), silicon (Si) or zirconium (Zr), which are the coating materials to be coated onto the surface of the titanium dioxide, are preferably used in 0.1 to 8 parts by weight, more preferably 0.3 to 6 parts by weight based on 100 parts by weight of the titanium dioxide, and the fatty acids stearate or alkyl silane conferring hydrophobicity is preferably coated in 0.1 to 10 parts by weight, more preferably 0.5 to 8 parts by weight.

In case of the zinc oxide, its particle size is equal to that of the titanium dioxide and it can be coated with stearate or alkyl silane to express hydrophobicity on its surface. Of course, it is possible to use commercially available products.

Either dry or wet coating method can be used to coat the zinc oxide. In case of the dry coating, it is preferable that the amount to be coated is 1 to 6 parts by weight, preferably 1.5 to 3 parts by weight based on 100 parts by weight of the zinc oxide, and in case of the wet coating, it is preferable that the amount to be coated is 1 to 8 parts by weight, preferably 2 to 5 parts by weight, and in order to prevent the yellowing of the zinc oxide in the preparation of dispersions, the wet coating is more preferable than the dry coating in that the former enables the coating of even single particle.

The dispersants, sulfosuccinate type or sulfosuccinamate type dispersion medium, are easily dissolved in water to be used, renders the hydrophobic fine powder-typed inorganic metal oxides to be well impregnated, improves dispersion property, and preferably use sulfosuccinate or sulfosuccinamate type compounds which are odorless, for example, there can be used at least one selected from the group consisting of disodium cetearyl sulfosuccinate, disodium deceth-5 sulfosuccinate, disodium oleyl sulfosuccinate, disodium isostearyl sulfosuccinate, disodium tridecyl sulfosuccinate, disodium stearyl sulfosuccinamate and tetrasodium dicarboxyethyl stearyl sulfosuccinamate.

Also, as the alkoxylated alcohol type dispersants, for example, there can be used at least one selected from the group consisting of polyoxyethylene (10) cetyl/stearyl ether, polyoxyethylene (6) cetyl/stearyl ether, polyoxyethylene (6) cetyl ether, polyoxyethylene (12) cetyl ether, polyoxyethylene (4) isodecyl ether, polyoxyethylene (12) isodecyl ether, polyoxyethylene (6) isolauryl ether, polyoxyethylene (5) isostearyl ether, polyoxyethylene (3) oleyl ether, polyoxyethylene (11) oleyl ether, polyoxyethylene (5) octyldodecyl ether and polyoxyethylene (10) octyldodecyl ether.

The disperse system having fine powder-typed inorganic metal oxide dispersed in water according to the invention is prepared by adding the hydrophobic fine powder-typed inorganic metal oxides to the solution obtained by premixing the dispersant with water and dissolving it, premixing them in a high speed stirrer (e.g., dissolver) or ball mill and then carrying out dispersion with a wet beads mill. Preferably, when the dispersion is carried out with the wet beads mill, the stirring speed is 2500 to 3700 rpm, more preferably, 2800 to 3300 rpm and it is preferably performed for 5 min to 1 hour.

In the preparation of the disperse system having fine powder-typed inorganic metal oxide dispersed in water, the amounts of respective ingredients can be selected, depending on the type of the cosmetics to be applied and preferably, a) 30 to 90% by weight of the hydrophobically treated fine powder-typed inorganic metal oxide; b) 0.1 to 30% by weight of the dispersant; and c) 0.1 to 60% by weight of the water are mixed. More preferably, a) 40 to 90% by weight of the hydrophobically treated fine powder-typed inorganic metal oxide; b) 5 to 20% by weight of the dispersant; and c) 3 to 40% by weight of the water are mixed. In particular, it is preferred that the total amount of a) the hydrophobically treated fine powder-typed inorganic metal oxide and b) the dispersant is at least 40% by weight or more. Within the above ranges, the stability of the prepared water dispersion is remarkably increased.

Further, the invention provides the disperse system having fine powder-typed inorganic metal oxide dispersed in water prepared by the above methods, and the water dispersion according to the invention preferably has an average particle diameter (D50) of 20 to 500 nm, more preferably 80 to 200 nm and within the above ranges, the transparency is especially remarkable.

Furthermore, the invention provides a cosmetic composition comprising the disperse system having fine powder-typed inorganic metal oxide dispersed in water, and the cosmetic composition according to the invention is preferably a cosmetic composition for sunscreen and other ingredients except the disperse system having fine powder-typed inorganic metal oxide dispersed in water can be chosen by one skilled in the pertinent art among the known cosmetic ingredients for sunscreen. Further, in the cosmetic composition of the invention, the content of the fine powder-typed inorganic metal oxide can be suitably adjusted to be suitable for respective products by one skilled in the pertinent art, and preferably, it is 0.1 to 50% by weight of the total cosmetic composition and more preferably, it is 1 to 30% by weight. Within the above ranges, it has the advantages such as light feelings, excellent moisture properties against sweat (water proof property) so that it can maintain UV protection ability for a long time and easy cleansing.

The present invention will be described in detail by reference to the preferred embodiments.

The following examples are provided to merely illustrate the invention and it would be obvious to any person having ordinary knowledge in the pertinent art that various modifications could be made within the spirit of the invention, and the scope of the invention is not limited to those illustrated in the following examples.

### EXAMPLES

### Example 1

5 Kg of pure water (resistivity: 18.0 MΩ/cm) was poured into a 10-L beaker, followed by the addition of 1 kg of hydrophilic fine powder-typed titanium dioxide (Tayca Company's Product: MT-100H) having an average particle diameter (D50) of 0.02 μm which was coated with Al₂O₃ on its surface. 60 G of dimethyldiethoxysilane was dissolved in 500 g of IPA (isopropyl alcohol) in a 2-L beaker to prepare a clear solution, which was then poured into the above slurry, stirred for 2 hours, dehydrated using a centrifuger, and dried for 12 hours at 120° C. and then the flocculated particles was pulverized using an atomizer.

After 150 g of the dispersant, disodium cetearyl sulfosuccinate was dissolved in 1350 g of pure water (resistivity: 18.0 MΩ/cm), 1 kg of the pulverized titanium dioxide obtained above was added thereto and premixing was carried out at 1000 rpm using a dissolver.

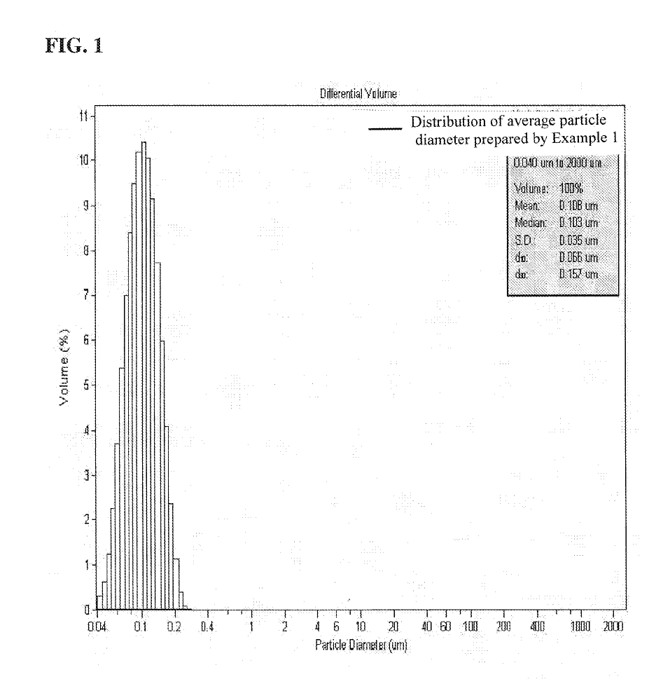

The obtained slurry was poured into a vertical type wet bead mill equipped with 0.1 mm zirconia beads therein (machine name: Super Apex mill, manufacturing company: KOTOBUKI Inc) and dispersion was carried out at 3200 rpm for 20 min to prepare water dispersion. The average particle diameter of the inorganic metal oxides (TiO₂) was measured with LS 13320 by COULTER Company and the results are shown in FIG. 1. FIG. 1 shows that the average particle diameter of the inorganic metal oxides was 100 nm, wherein the content of the inorganic metal oxides was 40% by weight.

### Example 2

2 Kg of fine powder-typed zinc oxide (Sunjin Chemical: SUNZNO-NAS) having an average particle diameter (D50) of 0.04 μm was poured into a Henschel mixer, and while the zinc oxide powders were being dispersed at 1500 rpm using a stirrer, 100 g of decyltriethoxysilane was dispersed, thereby carrying out the hydrophobic coating onto the zinc oxide powders. After the coated powders were dried for 12 hours at 120° C., the flocculated particles were pulverized using an atomizer.

After 300 g of the dispersant, disodium tridecyl sulfosuccinate, was dissolved in 1.7 kg of pure water (resistivity: 18.0 MΩ/cm), 2 kg of the pulverized hydrophobic zinc oxide obtained above was added thereto and premixing was carried out at 1000 rpm using a dissolver.

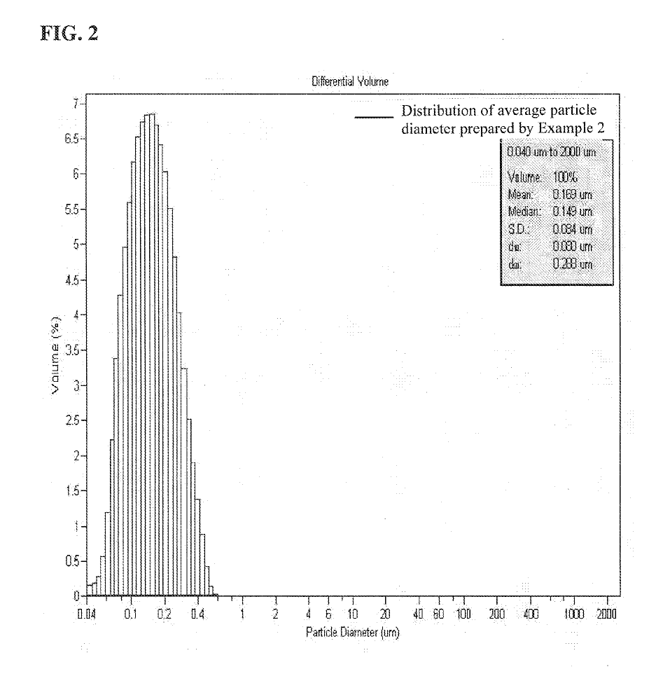

The obtained slurry was poured into a vertical type wet bead mill equipped with 0.1 mm zirconia beads therein (machine name: Super Apex mill, manufacturing company: KOTOBUKI Inc) and dispersion was carried out at 3000 rpm for 30 min to prepare water dispersion. The average particle diameter of the inorganic metal oxides (zinc oxide) was measured with LS 13320 by COULTER Company and the results are shown in FIG. 2. FIG. 2 shows that the average particle diameter of the inorganic metal oxides was 150 nm, wherein the content of the inorganic metal oxides was 50% by weight.

### Example 3

After 350 g of disodium oleyl sulfosuccinate and 10 g of disodium stearyl sulfosuccinamate as a dispersant was dissolved in 2.64 kg of pure water (resistivity: 18.0 MΩ/cm), 2 kg of the fine powder-typed titanium dioxide coated with Al(OH)₃ and stearic acid (Tayca Company's Product: MT-100TV) was added thereto and then premixing was carried out at 1200 rpm using a dissolver.

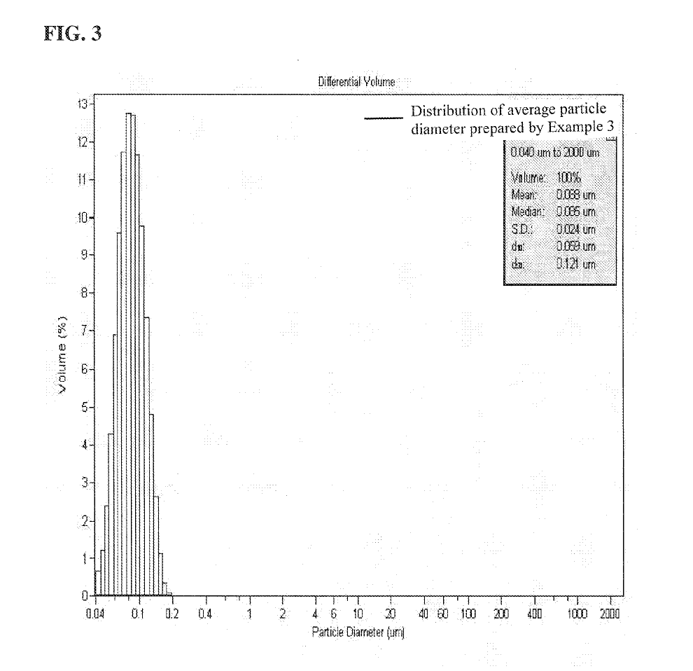

The obtained slurry was poured into a vertical type wet bead mill equipped with 0.1 mm zirconia beads therein (machine name: Super Apex mill, manufacturing company: KOTOBUKI Inc) and dispersion was carried out at 3500 rpm for 30 min to prepare water dispersion. The average particle diameter of the inorganic metal oxides (TiO₂) was measured with LS 13320 by COULTER Company and the results are shown in FIG. 3. FIG. 3 shows that the average particle diameter of the inorganic metal oxides was 90 nm, wherein the content of the inorganic metal oxides was 40% by weight.

### Example 4

10 Kg of pure water (resistivity: 18.0 MΩ/cm) was poured into a 20-L beaker, followed by the addition of 2 kg of hydrophilic fine powder-typed titanium dioxide (Tayca Company's Product: MT-100H) having an average particle diameter (D50) of 0.02 μm which was coated with Al₂O₃ on its surface.

80 G of decyltriethoxysilane was dissolved in 1 kg of IPA (isopropyl alcohol) in a 2-L beaker to prepare a clear solution, which was then poured into the above slurry, stirred for 2 hours and dried for 12 hours at 120° C. and then the flocculated particles was pulverized using an atomizer.

After 250 g of the dispersant, polyoxyethylene (12) cetyl ether, was poured into 2295 g of pure water (resistivity: 18.0 MΩ/cm, temperature: 50° C.) and dissolved for 1 hour, 2 kg of the pulverized titanium dioxide obtained above was added thereto and then milling was carried out at 250 rpm using a ball mill for 24 hours.

The obtained slurry was poured into a vertical type wet bead mill equipped with 0.1 mm zirconia beads therein (machine name: Super Apex mill, manufacturing company: KOTOBUKI Inc) and dispersion was carried out at 3300 rpm for 20 min to prepare water dispersion. The average particle diameter of the inorganic metal oxides (TiO₂) was measured with LS 13320 by COULTER Company and results similar to Example 1 were thus obtained, wherein the content of the inorganic metal oxides was 44% by weight.

### Example 5

2 Kg of fine powder-typed zinc oxide (Sunjin Chemical: SUNZNO-NAS) having an average particle diameter (D50) of 0.04 μm was poured into a Henschel mixer, and while the zinc oxide powders were being dispersed at 1500 rpm using a stirrer, 100 g of dimethyldiethoxysilane was dispersed, thereby carrying out the hydrophobic coating onto the zinc oxide powders. After the coated powders were dried for 12 hours at 120° C., the flocculated particles were pulverized using an atomizer.

After 400 g of the dispersant, polyoxyethylene (10) cetyl/stearyl ether, was dissolved in 1.6 kg of pure water (resistivity: 18.0 MΩ/cm, temperature: 40° C.), 2 kg of the pulverized hydrophobic zinc oxide obtained above was added thereto and then milling was carried out at 250 rpm using a ball mill for 24 hours.

The obtained slurry was poured into a vertical type wet bead mill equipped with 0.1 mm zirconia beads therein (machine name: Super Apex mill, manufacturing company: KOTOBUKI Inc) and dispersion was carried out at 3300 rpm for 30 min to prepare water dispersion. The average particle diameter of the inorganic metal oxides (zinc oxide) was measured with LS 13320 by COULTER Company and results similar to Example 2 were thus obtained, wherein the content of the inorganic metal oxides was 50% by weight.

### Example 6

Sun creams for UV protection were prepared using the water dispersions prepared in Examples 1 and 2. Respective ingredients used for preparing the sun creams and the content thereof are shown in Table 1 below and the units used in Table 1 are parts by weight.

TABLE 1

| No | Ingredients | Contents | INCI Name |
|---|---|---|---|
| A | CETIOL LC | 2 | Coco-Caprylate/Caprate |
| | DC345 | 4 | Cyclomethicone |
| | SALACOS99 | 2 | Isononyl Isononanoate |
| | KALCOHL6870 | 3 | Cetyl alcohol |
| | AR 165 | 2 | Glyceryl monostearate/ |
| | | | PEG-100 Stearate |
| | TWEEN 60 | 1.7 | Polysorbate 60 |
| | EMERSOL7036NF | 1 | Stearic acid |
| | PARSOLMCX | 7.5 | Octylmethoxycinnamate |
| | PARSOLEHS | 2 | Ethylhexyl Salicylate |
| | PARSOL5000 | 1 | 4-Methyoxydibenzoylmethane |
| | VEGEWAX70 | 1 | |
| | PP | 0.1 | |
| B | 1,3-B.G. | 6 | Butylene glycol |
| | 5% VEEGUM | 25 | Magnesium aluminum silicate |
| | WATER | 24.5 | WATER |
| | DC2501 WAX | 1 | Dimethicone copoyol |
| | MP | 0.1 | Methyl paraben |
| C | SUNSIL Tin40 | 2 | Silica & Titanium dioxide |
| | SUNPMMA | 1 | PolyMethyl Methacrylate |
| | Disperse System of Ex. 2 | 5 | |
| | Disperse System of Ex. 1 | 7 | |
| D | perfume | 0.1 | |
| | extract | 1 | |

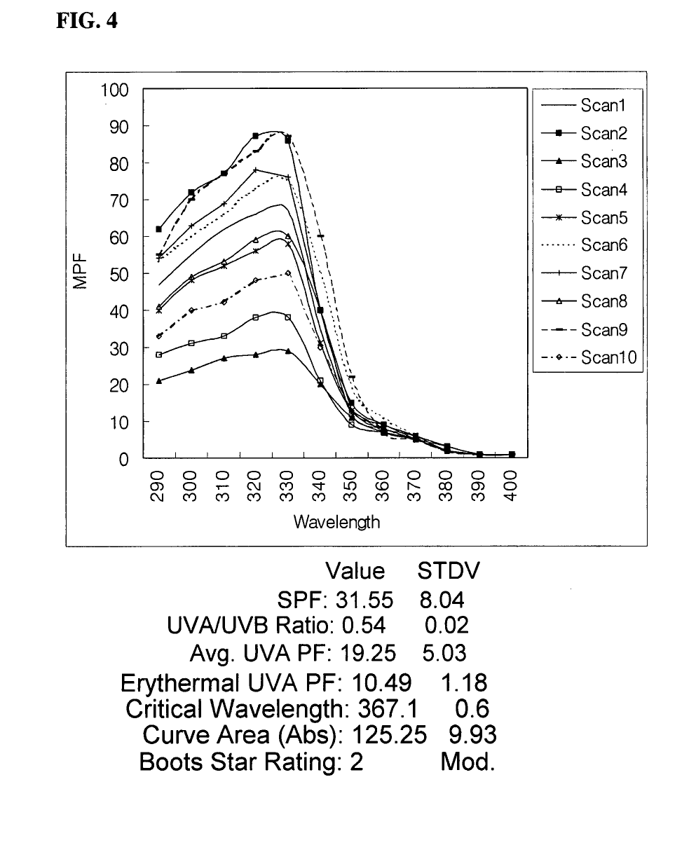

Sun protection factors of the sun creams prepared above were measured and shown in FIG. 4. The machine used for measurement is Optometrics 290 (manufacturing company: Optometrics USA Inc). As shown in FIG. 4, the cosmetic compositions of the invention had excellent UV protection effects.

### Example 7

Sun creams for UV protection were prepared using the water dispersions prepared in Examples 1 and 2. Respective ingredients used for preparing the sun creams and the content thereof are shown in Table 2 below and the units used in Table 2 are parts by weight.

TABLE 2

| No | Ingredients | Contents | INCI Name |
|---|---|---|---|
| A | CETIOL LC | 2 | Coco-Caprylate/Caprate |
| | DC345 | 4 | Cyclomethicone |
| | SALACOS99 | 2 | Isononyl Isononanoate |
| | KALCOHL6870 | 3 | Cetyl alcohol |
| | AR 165 | 2 | Glyceryl monostearate/ |
| | | | PEG-100 Stearate |
| | TWEEN 60 | 1.7 | Polysorbate 60 |
| | EMERSOL7036NF | 1 | Stearic acid |
| | PARSOLMCX | 7.5 | Octylmethoxycinnamate |
| | PARSOLEHS | 2 | Ethylhexyl Salicylate |
| | PARSOL5000 | 2 | 4-Methyoxydibenzoylmethane |
| | VEGEWAX700 | 1 | |
| | PP | 0.1 | |
| B | 1,3-B.G. | 6 | Butylene glycol |
| | 5% VEEGUM | 25 | Magnesium aluminum silicate |
| | WATER | 19.5 | WATER |
| | DC2501 WAX | 1 | Dimethicone copoyol |
| | MP | 0.1 | Methyl paraben |
| C | SUNSIL Tin40 | 3 | Silica & Titanium dioxide |
| | SUNPMMA | 1 | PolyMethyl Methacrylate |
| | Disperse System of Ex. 2 | 5 | |
| | Disperse System of Ex. 3 | 10 | |
| D | perfume | 0.1 | |
| | extract | 1 | |

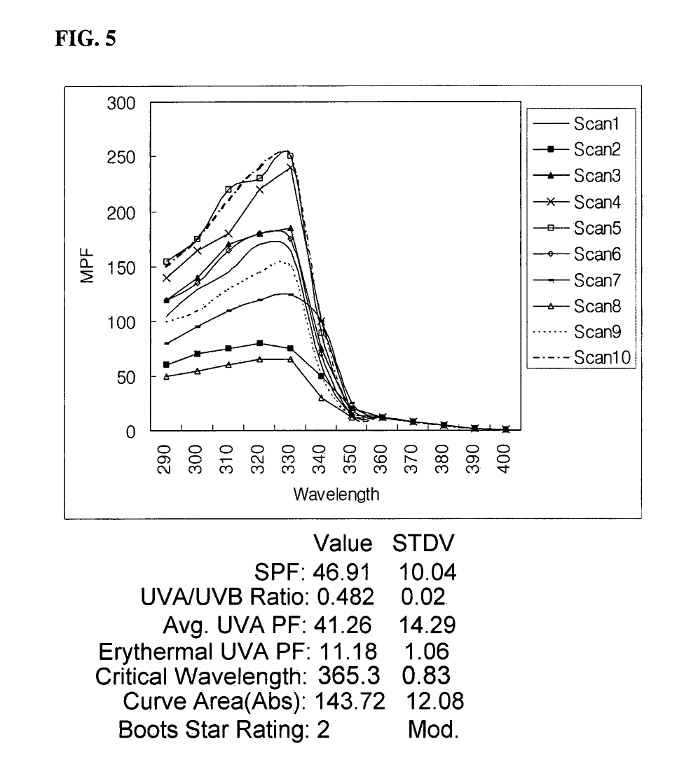

Sun protection factors of the sun creams prepared above were measured in accordance with the same methods as Example 6 and shown in FIG. 5. As shown in FIG. 5, the cosmetic compositions of the invention had excellent UV protection effects.

### Example 8

In preparation of the sun creams in Example 6, instead of the dispersions of Examples 1 and 2, the dispersions prepared in Examples 4 and 5 were mixed to prepare sun creams, and their sun protection factors were measured in accordance with the same methods as described in Example 6. As a result, it was verified that their UV protection effects were very similar to the results of Example 6.

The water dispersions of hydrophobically treated fine powder-types inorganic metal oxide in accordance with the present invention have high transparency in the visible ray spectrum, have light feelings when applied to cosmetic composition, and have excellent UV protection ability as well as excellent water proof property against moisture such as sweat.

What is claimed is:

1. A method for preparing a disperse system having fine powder-typed inorganic metal oxide dispersed in water, wherein
a) a hydrophobically treated fine powder-typed inorganic metal oxide;
b) a sulfosuccinate or sulfosuccinamate dispersant; and
c) water are mixed and dispersed by a high-speed bead mill.

2. The method for preparing the disperse system having fine powder-typed inorganic metal oxide dispersed in water according to claim 1, wherein in the mixing step,
a) 30 to 90% by weight of the hydrophobically treated fine powder-typed inorganic metal oxide;
b) 0.1 to 30% by weight of the sulfosuccinate or sulfosuccinamate dispersant; and
c) 0.1 to 60% by weight of the water are mixed and dispersed.

3. A method for preparing a disperse system having fine powder-typed inorganic metal oxide dispersed in water, wherein
a) a hydrophobically treated fine powder-typed inorganic metal oxide;
b) an alkoxylated alcohol dispersant; and
c) water are mixed and dispersed by a high-speed bead mill.

4. The method for preparing the disperse system having fine powder-typed inorganic metal oxide dispersed in water according to claim 3, wherein in the mixing step,
a) 30 to 90% by weight of the hydrophobically treated fine powder-typed inorganic metal oxide;
b) 0.1 to 30% by weight of the alkoxylated alcohol dispersant; and
c) 0.1 to 60% by weight of the water are mixed and dispersed.

5. The method for preparing the disperse system having fine powder-typed inorganic metal oxide dispersed in water according to claim 3, wherein the inorganic metal oxide has a particle size of 0.005 to 0.1 μm.

6. The method for preparing the disperse system having fine powder-typed inorganic metal oxide dispersed in water according to claim 3, wherein the total weight of a) the hydrophobically treated fine powder-typed inorganic metal oxide and b) the dispersant is at least 40% by weight.

7. The method for preparing the disperse system having fine powder-typed inorganic metal oxide dispersed in water according to claim 3, wherein a) the hydrophobically treated fine powder-typed inorganic metal oxide is coated with at least one of the hydroxide or oxide of aluminum (Al), silicon (Si) or zirconium (Zr) on its surface and its outermost portion is coated with fatty acids stearate of alkyl silane.

8. The method for preparing the disperse system having fine powder-typed inorganic metal oxide dispersed in water according to claim 1, wherein the dispersant is selected from the group consisting of disodium cetearyl sulfosuccinate, disodium deceth-5 sulfosuccinate, disodium oleyl sulfosuccinate, disodium isostearyl sulfosuccinate, disodium tridecyl sulfosuccinate, disodium stearyl sulfosuccinamate, tetrasodium dicarboxyethyl stearyl sulfosuccinamate, and a mixture thereof.

9. The method for preparing the disperse system having fine powder-typed inorganic metal oxide dispersed in water according to claim 3, wherein the dispersant is selected from the group consisting of polyoxyethylene (10) cetyl/stearyl ether, polyoxyethylene (6) cetyl/stearyl ether, polyoxyethylene (6) cetyl ether, polyoxyethylene (12) cetyl ether, polyoxyethylene (4) isodecyl ether, polyoxyethylene (12) isodecyl ether, polyoxyethylene (6) isolauryl ether, polyoxyethylene (5) isostearyl ether, polyoxyethylene (3) oleyl ether, polyoxyethylene (11) oleyl ether, polyoxyethylene (5) octyldodecyl ether, polyoxyethylene (10) octyldodecyl ether, and a mixture thereof.

10. The method for preparing the disperse system having fine powder-typed inorganic metal oxide dispersed in water according to claim 3, wherein the dispersing step is carried out by using the bead mill at 2500 to 3700 rpm.

11. A disperse system having fine powder-typed inorganic metal oxide dispersed in water prepared by the method of claim 3.

12. The disperse system having fine powder-typed inorganic metal oxide dispersed in water according to claim 11, wherein the average particle diameter of the inorganic metal oxide in the disperse system having fine powder-typed inorganic metal oxide dispersed in water is 80 to 200 nm.

13. A cosmetic composition comprising 0.1 to 50% by weight of the disperse system having fine powder-typed inorganic metal oxide dispersed in water as described in claim 11.

14. The method for preparing the disperse system having fine powder-typed inorganic metal oxide dispersed in water according to claim 1, wherein the inorganic metal oxide has a particle size of 0.005 to 0.1 μm.

15. The method for preparing the disperse system having fine powder-typed inorganic metal oxide dispersed in water according to claim 1, wherein the total weight of a) the hydrophobically treated fine powder-typed inorganic metal oxide and b) the dispersant is at least 40% by weight.

16. The method for preparing the disperse system having fine powder-typed inorganic metal oxide dispersed in water according to claim 1, wherein a) the hydrophobically treated fine powder-typed inorganic metal oxide is coated with at least one of the hydroxide or oxide of aluminum (Al), silicon (Si) or zirconium (Zr) on its surface and its outermost portion is coated with fatty acids stearate of alkyl silane.

17. The method for preparing the disperse system having fine powder-typed inorganic metal oxide dispersed in water according to claim 1, wherein the dispersing step is carried out by using the bead mill at 2500 to 3700 rpm.

18. A disperse system having fine powder-typed inorganic metal oxide dispersed in water prepared by the method of claim 1.
